(19) United States
(12) Patent Application Publication
(10) Pub. No.: US 2019/0071866 A1
(43) Pub. Date: Mar. 7, 2019

(54) INSULATING MATERIALS

(71) Applicant: Ilsin Industrial Co., Ltd., Gyeongsan-si (KR)

(72) Inventors: Jeong Gon SONG, Gyeongsan-si (KR); Yang Oh KIM, Miryang-si (KR)

(21) Appl. No.: 16/113,383

(22) Filed: Aug. 27, 2018

(30) Foreign Application Priority Data
Sep. 1, 2017 (KR) 10-2017-0112167
Aug. 14, 2018 (KR) 10-2018-0094983

(51) Int. Cl. E04B 1/80; B32B 3/12

(52) U.S. Cl. CPC E04B 1/806; B32B 3/12; B32B 2419/00; B32B 2307/304; B32B 2250/40

(57) ABSTRACT

Insulating materials which reduce heat loss are provided. The insulating materials include an air layer forming portion which forms a plurality of air layers, a lower cover portion which covers a lower side of the air layer forming portion, and an upper cover portion which covers an upper side of the air layer forming portion. Here, the lower cover portion and the upper cover portion insulate the air layers from the outside.

### CROSS-REFERENCE TO RELATED APPLICATION

This application claims priority to and the benefit of Korean Patent Application No. 10-2017-0112167 and 10-2018-0094983, filed on Sep. 1, 2017 and Aug. 14, 2018 the disclosure of which is incorporated herein by reference in its entirety.

### BACKGROUND

### 1. Field of the Invention

The present invention relates to insulating materials, and more particularly, to insulating materials which increase insulation performance of a building.

### 2. Discussion of Related Art

In buildings, heat transfer occurs inside and outside overall buildings and it is no exaggeration to say that transfer through walls occupies half of such heat transfer.

Through micro air holes in concrete or bricks which form a wall, air moves in to an inside and out to an outside of a building such that undesirable heat transfer occurs.

Accordingly, thermal insulation of a building is enacted by human wisdom to stay cool in summer and warm in winter at a low cost by efficiently managing cooling and heating energies by preventing heat transfer in and out of the building.

That is, a significant purpose of heat insulation may be to reduce a capacity of an air-conditioning system and reduce annual air-conditioning energy consumption by suppressing undesirable heat loss or heat gain of a building.

As an effect of heat insulation, still air is best. The still air is known as providing a higher heat insulation effect than any insulating materials at a room temperature of 20° C.

Accordingly, a still air cell structure or materials such as foaming polystyrene and the like in which air is used are the basis of insulating materials.

Hence, Korean Patent Publication No. 10-2018-0033675 A (published on Apr. 4, 2018) discloses a multifunctional insulation which has all of flame-retardant, noise-absorbing, and moisture-proofing functions by using a first foaming polystyrene mesh resin 31 having an air layer structure with a certain thickness and first and second aluminum foils 21 and 22.

However, air which is convected in an air layer moves to a space between the resin 31 and the aluminum foil 22 and leaks into an adjacent air layer such that insulating efficiency decreases.

### SUMMARY OF THE INVENTION

The present invention is directed to providing insulating materials capable of maximizing insulating efficiency by using air layers.

Aspects of the present invention will not be limited to the above-described aspect, and unstated aspects can be clearly understood by those skilled in the art through the specification and the attached drawings.

According to one aspect of the present invention, insulating materials, which reduce heat loss, include an air layer forming portion which forms a plurality of air layers, a lower cover portion which covers a lower side of the air layer forming portion, and an upper cover portion which covers an upper side of the air layer forming portion. Here, the lower cover portion and the upper cover portion insulate the air layers from the outside.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic perspective view of insulating materials according to one embodiment of the present invention;

FIG. 2 is a schematic exploded perspective view of the insulating materials according to one embodiment of the present invention;

FIG. 3 is a schematic plane view illustrating an air layer forming portion according to one embodiment of the present invention;

FIG. 4 is a schematic exploded perspective view illustrating an air layer forming portion according to a second embodiment of the present invention;

FIG. 5 is a schematic plane view illustrating the air-layer forming portion according to the second embodiment of the present invention;

FIG. 6 is a schematic plane view illustrating an air-layer forming portion according to a third embodiment of the present invention;

FIG. 7 is a schematic plane view illustrating an air layer forming portion according to a fourth embodiment of the present invention;

FIG. 8 is a schematic cross-sectional view illustrating convection of air on an air layer of the insulating materials according to one embodiment of the present invention;

FIGS. 9 and 10 are schematic cross-sectional views illustrating a guide portion according to one embodiment of the present invention;

FIG. 11 is a schematic perspective view of insulating materials according to the second embodiment of the present invention;

FIG. 12 is a schematic exploded perspective view of the insulating materials according to the second embodiment of the present invention;

FIGS. 13, 14A, and 14B are schematic perspective and plane views illustrating a process of manufacturing the air layer forming portion of the insulating materials according to the second embodiment of the present invention;

FIG. 15 is a schematic plane view illustrating the air-layer forming portion of the insulating materials according to the second embodiment of the present invention; and

FIG. 16 is a schematic diagram illustrating a central line of the air layer forming portion to explain the air layer forming portion of the insulating materials according to the second embodiment of the present invention.

### DETAILED DESCRIPTION OF EXEMPLARY EMBODIMENTS

Hereinafter, detailed embodiments of the present invention will be described with reference to the drawings. However, the concept of the present invention is not limited to the disclosed embodiments. It should be understood that other foregoing inventions or other embodiments included in the conceptual scope of the present invention may be easily provided by one of ordinary skill in the art through addition, change, deletion, and the like of other components, but they will be included within the scope of the present invention.

According to one aspect of the present invention, insulating materials, which reduce heat loss, include an air layer forming portion which forms a plurality of air layers, a lower cover portion which covers a lower side of the air layer forming portion, and an upper cover portion which covers an upper side of the air layer forming portion. Here, the lower cover portion and the upper cover portion insulate the air layers from the outside. The insulating materials may further include a guide portion which is disposed on the air layer and guides a convection path on the air layer.

The guide portion may be disposed to be adjacent to a contact area between the lower cover portion and/or the upper cover portion and the air layer forming portion so as to prevent air, which is convected in the air layers, from leaking into the contact area between the lower cover portion and/or the upper cover portion and the air layer forming portion.

The guide portion may come into contact with the lower cover portion and/or the upper cover portion and come into contact with the air layer forming portion so as to increase the contact area between the lower cover portion and/or the upper cover portion and the air layer forming portion.

The guide portion may extend along the air layer forming portion and may have different thicknesses at a first point and a second point spaced apart from the first point along the air layer forming portion.

According to another aspect of the present invention, insulating materials, which reduce heat loss, include an air layer forming portion which forms a plurality of air layers, a lower cover portion which covers a lower side of the air layer forming portion, and an upper cover portion which covers an upper side of the air layer forming portion. Here, the lower cover portion and the upper cover portion insulate the air layers from the outside. The air layer forming portion includes a first air layer forming portion and a second air layer forming portion which partially adheres to the first air layer forming portion to form the air layers in cooperation with the first air layer forming portion. The first air layer forming portion includes a 1-1 surface, a 1-2 surface, which is bent and extends from the 1-1 surface, and a 1-3 surface, which is bent and extends from the 1-2 surface, so as to form a first air layer which is one of the plurality of air layers. The second air layer forming portion includes a 2-1 surface, a 2-2 surface which is bent and extends from the 2-1 surface, and a 2-3 surface, which is bent and extends from the 2-2 surface, so as to form the first air layer in cooperation with the first air layer forming portion. The first air layer forming portion includes a 3-1 surface, a 3-2 surface, which is bent and extends from the 3-1 surface, and a 3-3 surface, which is bent and extends from the 3-2 surface, so as to form a second air layer which is one of the plurality of air layers and is spaced apart from the first air layer in a longitudinal direction. The second air layer forming portion includes a 4-1 surface, a 4-2 surface, which is bent and extends from the 4-1 surface, and a 4-3 surface, which is bent and extends from the 4-2 surface, so as to form the second air layer in cooperation with the first air layer forming portion. The first air layer forming portion further includes a first connection surface which connects the 1-3 surface to the 3-1 surface so as to transfer an external force applied to the 1-3 surface to the 3-1 surface while the first air layer and the second air layer are spaced apart. The second air layer forming portion further includes a second connection surface which connects the 2-3 surface to the 4-1 surface so as to transfer an external force applied to the 2-3 surface to the 4-1 surface while the first air layer and the second air layer are spaced apart. The first connection surface and the second connection surface adhere to each other so as to increase durability against an external force.

The 1-3 surface and the 2-3 surface may form a first apex. The 3-1 surface and the 4-1 surface may form a second apex. The second apex may be spaced apart from the first apex in a lateral direction so as to increase durability against an external force applied in the longitudinal direction.

The 1-2 surface and the 1-3 surface may form a third apex, and the second apex may be formed between the first apex and the third apex in a lateral direction.

The first air layer forming portion may include a 5-1 surface, a 5-2 surface which is bent and extends from the 5-1 surface, and a 5-3 surface which is bent and extends from the 5-2 surface so as to form a third air layer which is one of the plurality of air layers and is spaced apart from the second air layer in a longitudinal direction. The second air layer forming portion may include a 6-1 surface, a 6-2 surface which is bent and extends from the 6-1 surface, and a 6-3 surface which is bent and extends from the 6-2 surface so as to form the third air layer in cooperation with the first air layer forming portion. The first air layer forming portion may further include a third connection surface which connects the 3-3 surface to the 5-1 surface so as to transfer an external force applied to the 3-3 surface to the 5-1 surface while the second air layer and the third air layer are spaced apart. The second air layer forming portion may further include a fourth connection surface which connects the 4-3 surface to the 6-1 surface so as to transfer an external force applied to the 4-3 surface to the 6-1 surface while the second air layer and the third air layer are spaced apart. The 3-3 surface and the 4-3 surface may form a fourth apex. The 5-1 surface and the 6-1 surface may form a fifth apex. The fifth apex may be spaced apart from the fourth apex in the lateral direction so as to increase durability against an external force applied in the longitudinal direction.

An angle between a virtual straight line, which connects the first apex to the second apex, and a virtual reference axis in the lateral direction may differ from an angle between a virtual straight line, which connects the fourth apex to the fifth apex, and the virtual reference axis.

Elements in the drawings with respect to each of embodiments which have the same function within the equal conceptual scope will be described as being referred to as like reference numerals.

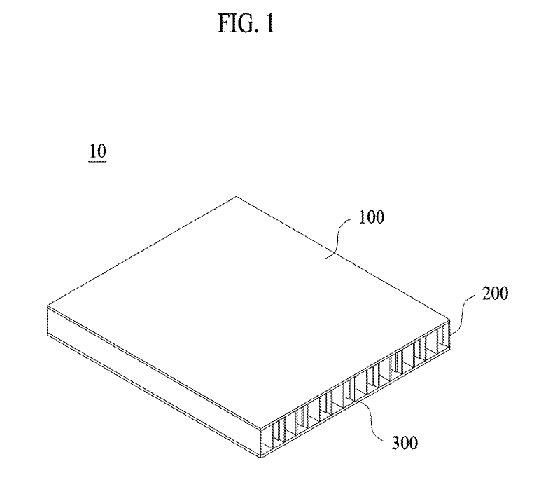

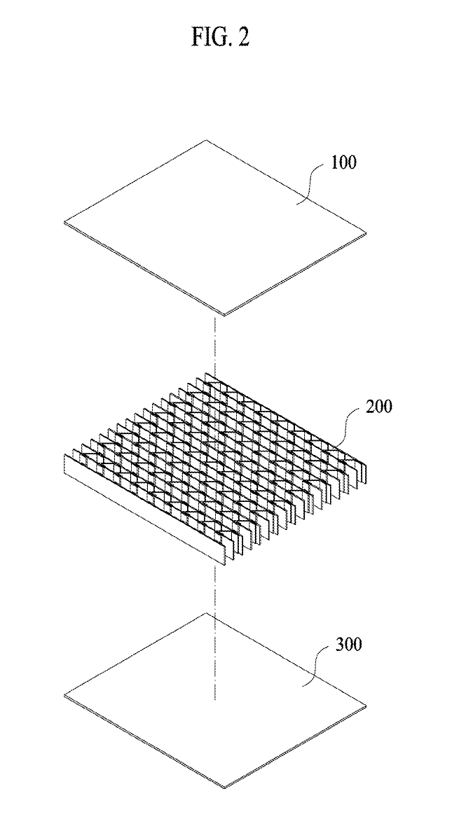

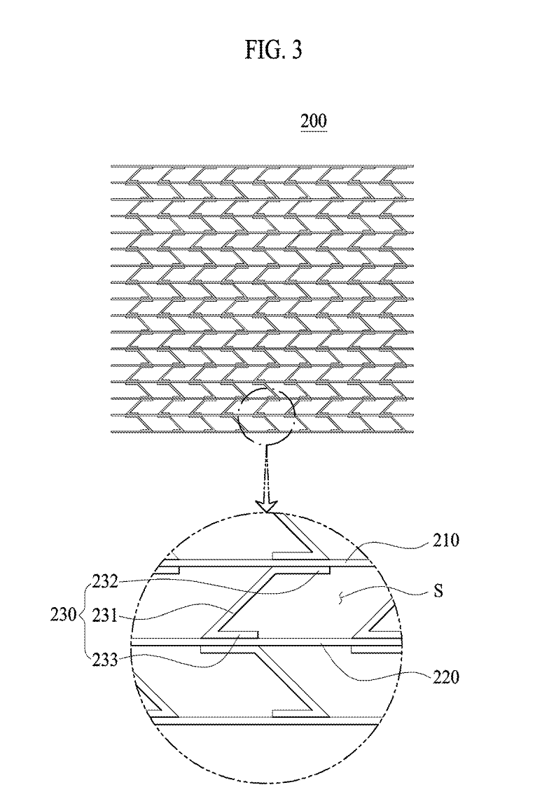

FIG. 1 is a schematic perspective view of insulating materials according to one embodiment of the present invention. FIG. 2 is a schematic exploded perspective view of the insulating materials according to one embodiment of the present invention. FIG. 3 is a schematic plane view illustrating an air layer forming portion according to one embodiment of the present invention.

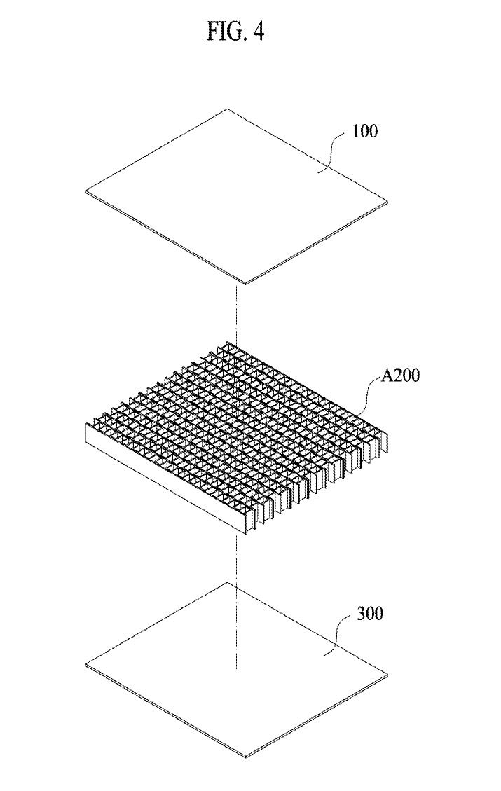

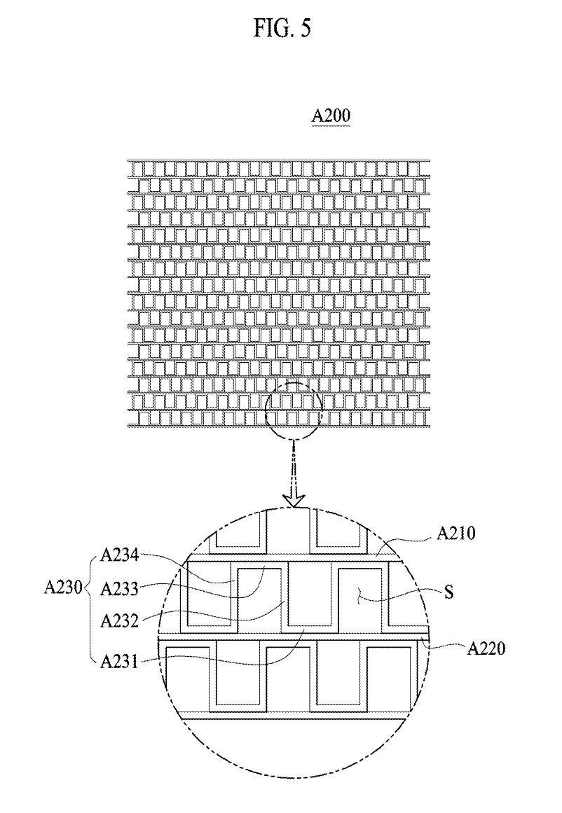

FIG. 4 is a schematic exploded perspective view illustrating an air layer forming portion according to a second embodiment of the present invention. FIG. 5 is a schematic plane view illustrating the air-layer forming portion according to the second embodiment of the present invention.

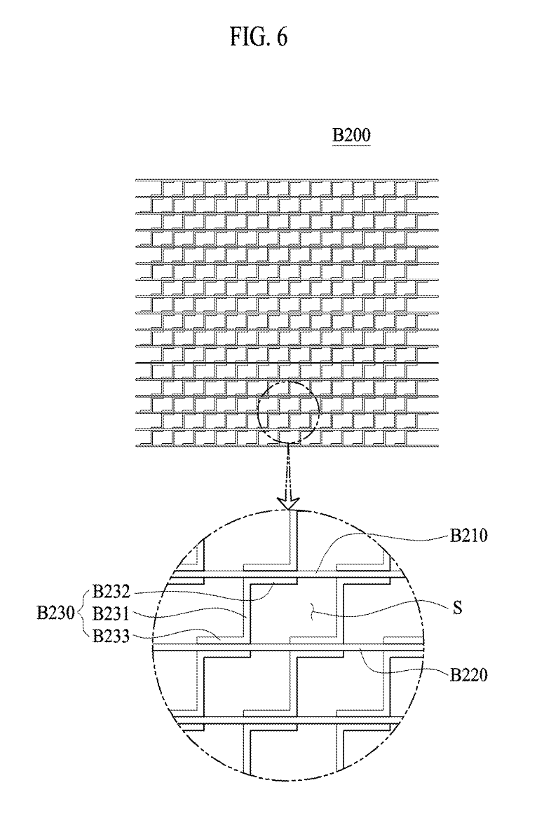

FIG. 6 is a schematic plane view illustrating an air-layer forming portion according to a third embodiment of the present invention.

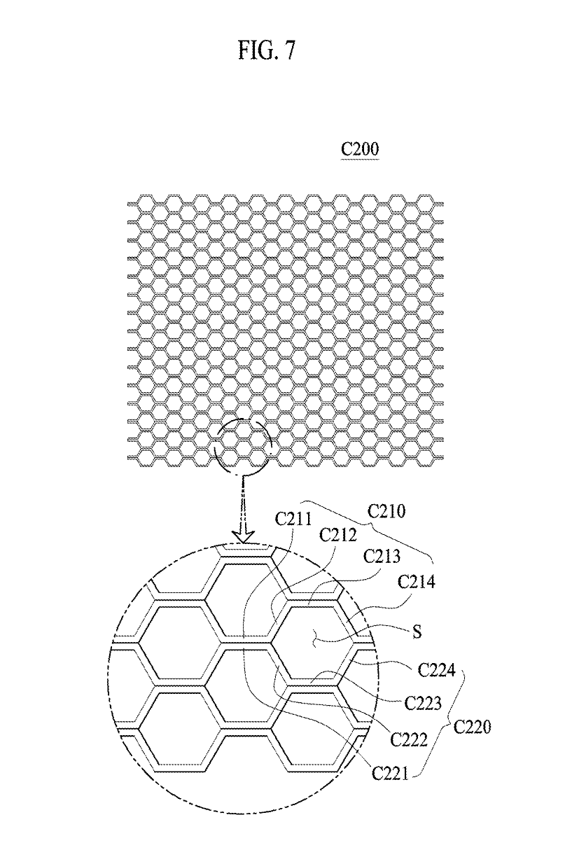

FIG. 7 is a schematic plane view illustrating an air layer forming portion according to a fourth embodiment of the present invention.

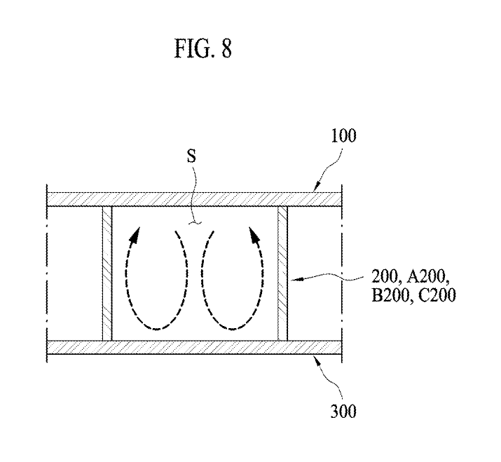

FIG. 8 is a schematic cross-sectional view illustrating convection of air on an air layer of the insulating materials according to one embodiment of the present invention.

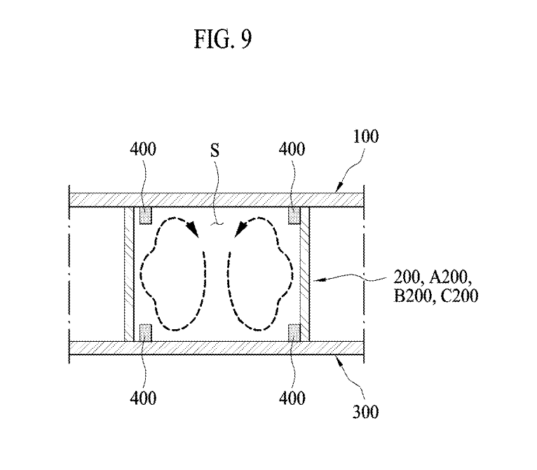

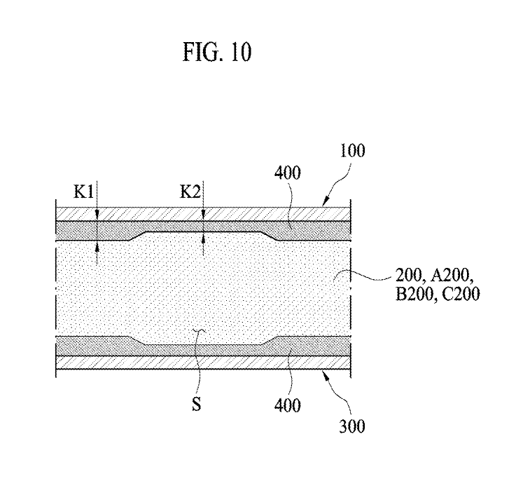

FIG. 9 is a schematic cross-sectional view illustrating a guide portion according to one embodiment of the present invention. FIG. 10 is a schematic cross-sectional view illustrating the guide portion according to one embodiment of the present invention in a direction perpendicular to a direction of the cross section of FIG. 9

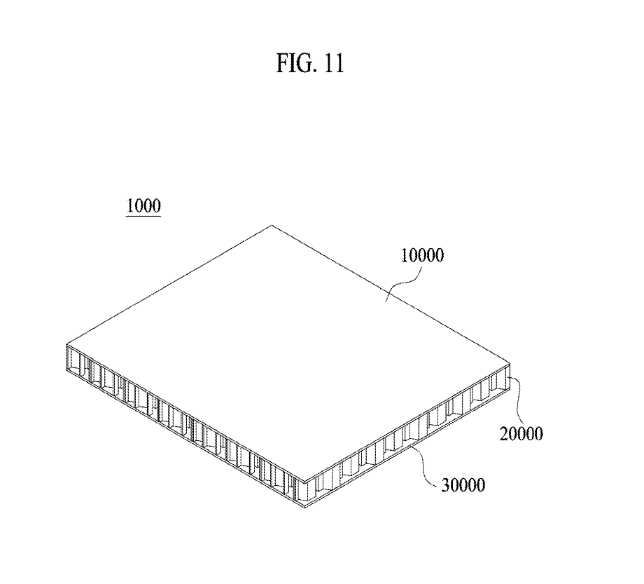

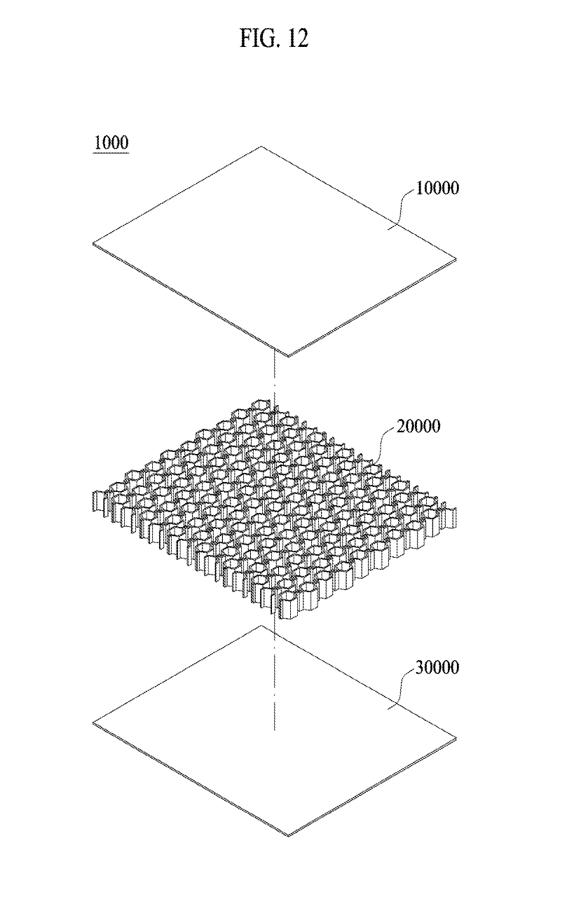

FIG. 11 is a schematic perspective view of insulating materials according to the second embodiment of the present invention. FIG. 12 is a schematic exploded perspective view of the insulating materials according to the second embodiment of the present invention.

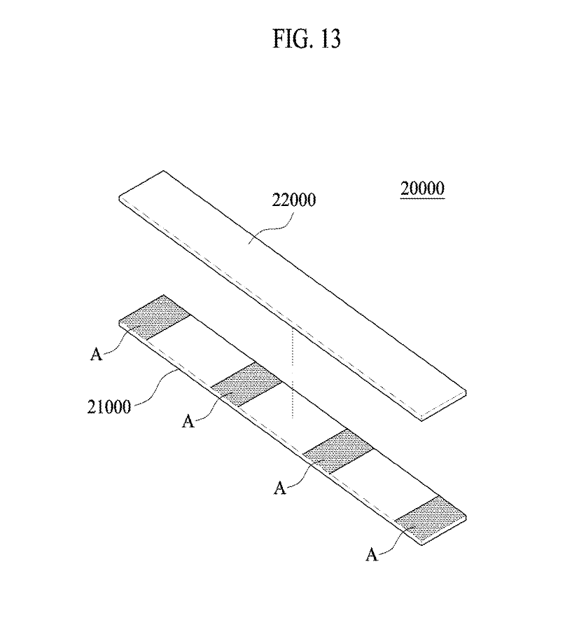

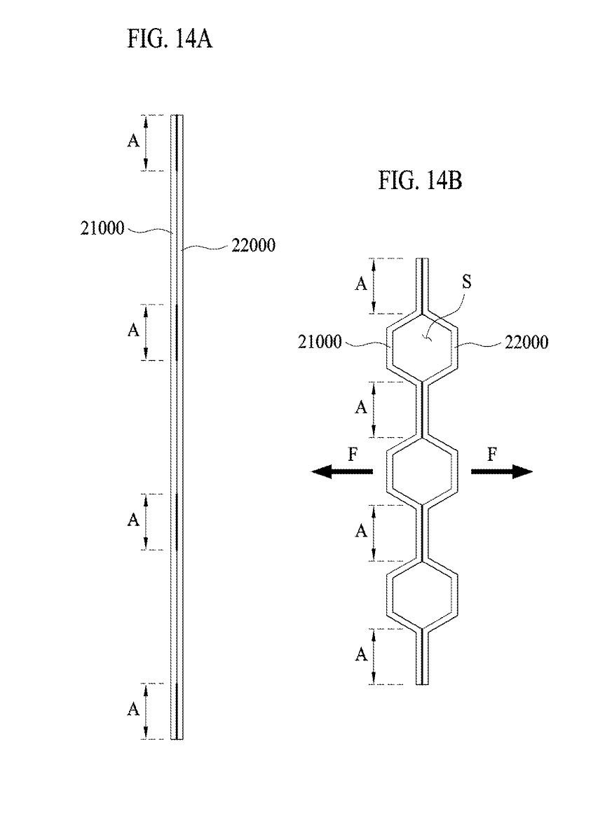

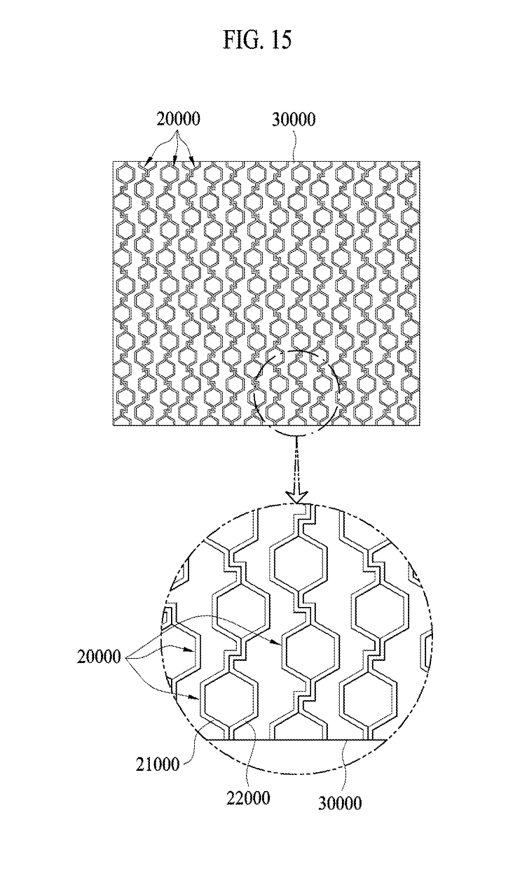

FIGS. 13, 14A, and 14B are schematic perspective and plane views illustrating a process of manufacturing the air layer forming portion of the insulating materials according to the second embodiment of the present invention. FIG. 15 is a schematic plane view illustrating the air-layer forming portion of the insulating materials according to the second embodiment of the present invention.

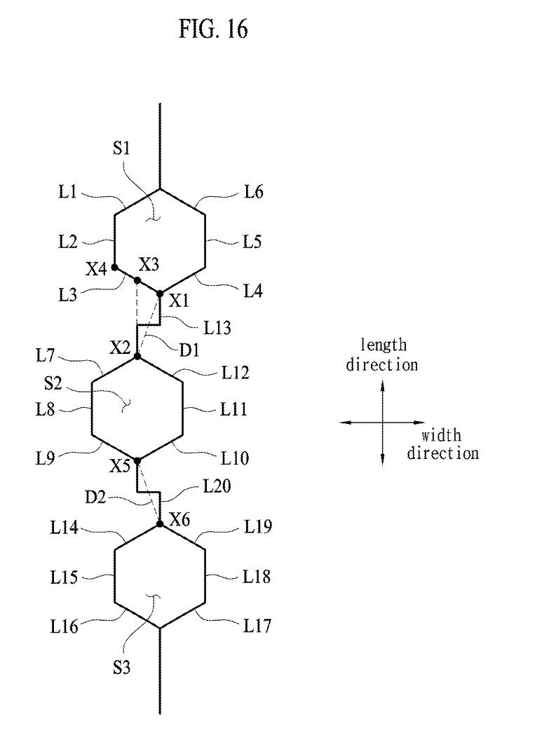

FIG. 16 is a schematic diagram illustrating a central line of the air layer forming portion to explain the air layer forming portion of the insulating materials according to the second embodiment of the present invention.

In the attached drawings, in order to more accurately describe the technical concept of the present invention, parts which are less relevant to the technical concept of the present invention or are easily derived by those skilled in the art are simplified or omitted.

As shown in FIGS. 1 to 3, insulating materials 10 according to one embodiment of the present invention may be a component which reduces heat loss of a structure such as a building and the like.

As an example, the insulating materials 10 may include an air layer forming portion 200 which forms a plurality of air layers S, a lower cover portion 300 which covers a lower side of the air layer forming portion 200, and an upper cover portion 100 which covers an upper side of the air layer forming portion 200.

As an example, the lower cover portion 300 and the upper cover portion 100 may adhere to the air layer forming portion 200 through an adhesive and the like.

As an example, adhesion between the lower cover portion 300 and the air layer forming portion 200 and adhesion between the upper cover portion 100 and the air layer forming portion 200 may be embodied by applying an adhesive thereto and applying a thermal treatment of heating the portions with a certain heat.

Accordingly, the lower cover portion 300 and the upper cover portion 100 may insulate the air layers S from the outside.

As an example, the lower cover portion 300 and the upper cover portion 100 may be formed of an aluminum material but are not limited thereto and may be variously changed by one of ordinary skill in the art.

As an example, the air layer forming portion 200 may have a certain thickness.

As an example, the air layer forming portion 200 may form the plurality of air layers S which are divided from one other.

As an example, as shown in FIG. 3, the air layer forming portion 200 may include a first extension portion 210 which extends in a longitudinal direction (left and rightwards in FIG. 3) and a second extension portion 220 which is spaced apart from the first extension portion 210 in a lateral direction (up and downwards in FIG. 3) and extends in the longitudinal direction.

As an example, pluralities of such first extension portions 210 and second extension portions 220 may be alternately repeated and spaced apart in the lateral direction.

Here, the air layer forming portion 200 may further include a division portion 230 disposed between the first extension portion 210 and the second extension portion 220 to form the plurality of air layers S which are spaced apart from each other.

As an example, a plurality of such division portions 230 may be arranged while being spaced a certain distance apart in the longitudinal direction such that the plurality of air layers S may be formed between the first extension portion 210 and the second extension portion 220.

As an example, the division portion 230 may include a first division portion 232 which is in contact with the first extension portion 210, a second division portion 231 which is bent and extends from the first division portion 232 and divides a space between the first extension portion 210 and the second extension portion 220, and a third division portion 233 which is bent and extends from the second division portion 231 and comes into contact with the second extension portion 220.

As an example, the first division portion 232 and the third division portion 233 may be bent in the same direction on the basis of the second division portion 231.

As an example, the plurality of division portions 230 may be arranged between the first extension portion 210 and the second extension portion 220 which are repeatedly arranged to be spaced apart in the lateral direction.

The division portions 230 which are adjacent to each other in the lateral direction may be symmetrically arranged on the basis of a virtual axis in the lateral direction.

As a result thereof, the air layer forming portion 200 may not be damaged by an unintended external force applied thereto and durability thereof may increase.

As an example, the first extension portion 210, the second extension portion 220, and the division portion 230 may include a paper material and may adhere to one another due to adhesives.

Hereinafter, a second embodiment of the air layer forming portion 200 will be described with reference to FIGS. 4 and 5.

As an example, as shown in FIG. 5, an air layer forming portion A200 according to the second embodiment may include a first extension portion A210 which extends in a longitudinal direction (left and rightwards in FIG. 5) and a second extension portion A220 which is spaced apart from the first extension portion A210 in a lateral direction (up and downwards in FIG. 5) and extends in the longitudinal direction.

As an example, pluralities of such first extension portions A210 and second extension portions A220 may be alternately repeated and spaced apart in the lateral direction.

Here, the air layer forming portion A200 may further include a division portion A230 disposed between the first extension portion A210 and the second extension portion A220 to form a plurality of air layers S which are spaced apart. The division portion A230 may be bent and extend in the longitudinal direction so as to form the plurality of air layers S between the first extension portion A210 and the second extension portion A220.

As an example, the air layer forming portion A200 may include a first division portion A231 which is in contact with the second extension portion A220, a second division portion A232 which is bent and extends from the first division portion A231 and divides a space between the first extension portion A210 and the second extension portion A220, a third division portion A233 which is bent and extends from the second division portion A232 and comes into contact with the first extension portion A210, and a fourth division portion A234 which is bent and extends from the third division portion A233 and divides a space between the first extension portion A210 and the second extension portion A220.

As an example, the first division portion A231 may be bent again and extend from the fourth division portion A234 and such patterns may be repeated such that the division portion A230 may form the plurality of air layers S in the space between the first extension portion 210 and the second extension portion A220.

As an example, a plurality of such division portions A230 may be arranged between the first extension portion A210 and the second extension portion A220 which are repeatedly arranged to be spaced apart in the lateral direction.

The division portions A230 which are adjacent to each other in the lateral direction may be alternately arranged.

As a result thereof, the air layers S, which are adjacent to each other in the lateral direction, may partially overlap with each other in the lateral direction.

As a result thereof, the air layer forming portion A200 may not be damaged by an unintended external force applied thereto and durability thereof may increase.

As an example, the first extension portion A210, the second extension portion A220, and the division portion A230 may have a paper material and may adhere to one another due to adhesives.

Hereinafter, a third embodiment of the air layer forming portion 200 will be described with reference to FIG. 6.

As an example, as shown in FIG. 6, an air layer forming portion B200 according to the third embodiment may include a first extension portion B210 which extends in a longitudinal direction (left and rightwards in FIG. 6) and a second extension portion B220 which is spaced apart from the first extension portion B210 in a lateral direction (up and downwards in FIG. 6) and extends in the longitudinal direction.

As an example, pluralities of such first extension portions B210 and second extension portions B220 may be alternately repeated and spaced apart in the lateral direction.

Here, the air layer forming portion B200 may further include a division portion B230 disposed between the first extension portion B210 and the second extension portion B220 to form a plurality of air layers S which are spaced apart.

As an example, a plurality of such division portions B230 may be arranged to be spaced a certain distance apart in the longitudinal direction such that the plurality of air layers S may be formed between the first extension portion B210 and the second extension portion B220.

As an example, the division portion B230 may include a first division portion B232 which is in contact with the first extension portion B210, a second division portion B231 which is bent and extends from the first division portion B232 and divides a space between the first extension portion B210 and the second extension portion B220, and a third division portion B233 which is bent and extends from the second division portion 231 and comes into contact with the second extension portion B220.

As an example, the first division portion B232 and the third division portion B233 may be bent in different directions on the basis of the second division portion B231.

As an example, a plurality of such division portions B230 may be arranged between the first extension portion B210 and the second extension portion B220 which are repeatedly arranged while being spaced apart in the lateral direction.

The division portions B230 which are adjacent to each other in the lateral direction may be arranged to be symmetrical on the basis of a certain point on the second extension portion B220.

As a result thereof, the air layers S, which are adjacent to each other in the lateral direction, may partially overlap with each other in the lateral direction.

As a result thereof, the air layer forming portion B200 may not be damaged by an unintended external force applied thereto and durability thereof may increase.

As an example, the first extension portion B210, the second extension portion B220, and the division portion B230 may have a paper material and may adhere to one another due to adhesives.

Hereinafter, a fourth embodiment of the air layer forming portion 200 will be described with reference to FIG. 7.

As an example, as shown in FIG. 7, an air layer forming portion C200 according to the fourth embodiment may include a first extension portion C210 which extends in a longitudinal direction (left and rightwards in FIG. 7) and a second extension portion C220 which is adjacent to the first extension portion C210 in a lateral direction (in FIG. 7) and is bent and extends in the longitudinal direction.

The first extension portion C210 and the second extension portion C220 may come into partial contact with each other and be partially spaced apart so as to form a plurality of air layers S.

As an example, the first extension portion C210 may include a 1-1 extension portion C211 which comes into contact with the second extension portion C220, a 1-2 extension portion C212 which is bent and extends from the 1-1 extension portion C211, a 1-3 extension portion C213 which is bent and extends from the 1-2 extension portion C212, and a 1-4 extension portion C214 which is bent and extends from the 1-3 extension portion C213.

As an example, the 1-1 extension portion C211 may be bent again and extend from the 1-4 extension portion C214 and such patterns may be repeated such that the plurality of air layers S may be formed in a space between the first extension portion C210 and the second extension portion C220.

As an example, the second extension portion C220 may include a 2-1 extension portion C221 which comes into contact with the 1-1 extension portion C211, a 2-2 extension portion C222 which is bent and extends from the 2-1 extension portion C221, a 2-3 extension portion C223 which is bent and extends from the 2-2 extension portion C222, and a 2-4 extension portion C224 which is bent and extends from the 2-3 extension portion C223.

As an example, the 2-1 extension portion C221 may be bent again and extend from the 2-4 extension portion C224 and such patterns may be repeated such that the plurality of air layers S may be formed in the space between the first extension portion C210 and the second extension portion C220.

As an example, pluralities of such first extension portions C210 and second extension portions C220 may be alternately repeated in the lateral direction.

Hereinafter, a guide portion 400 included in the insulating materials 10 will be described with reference to FIGS. 8 to 10.

FIG. 8 is a cross-sectional view illustrating convection of air caused by heat in the air layers S formed by the air layer forming portion 200, A200, B200, or C200. As shown in FIG. 8, when a temperature difference occurs between the lower cover portion 300 and the upper cover portion 100, the air in the air layers S may be convected.

Here, when adhesion between the lower cover portion 300 and the air layer forming portion 200, A200, B200, or C200 or adhesion between the upper cover portion 100 and the air layer forming portion 200, A200, B200, or C200 is not strong or an unintended external force is applied during a process of constructing the insulating materials 10, micro gaps may occur between the lower cover portion 300 and the air layer forming portion 200, A200, B200, or C200 or between the upper cover portion 100 and the air layer forming portion 200, A200, B200, or C200.

In this case, the air which is convected in the air layer S may leak into the adjacent air layer S through a space between the lower cover portion 300 and the air layer forming portion 200, A200, B200, or C200 or between the upper cover portion 100 and the air layer forming portion 200, A200, B200, or C200.

This leak may be fatal to securing insulation performance.

Accordingly, as shown in FIGS. 9 and 10, as an example, the insulating materials 10 may further include the guide portion 400 which is disposed on the air layers S and guides a convection path on the air layer S.

As an example, the guide portion 400 may be disposed inside the lower cover portion 300 and/or the upper cover portion 100 or may be disposed on the air layer forming portion 200, A200, B200, or C200.

As an example, the guide portion 400 may be disposed to be adjacent to a contact area between the lower cover portion 300 and/or the upper cover portion 100 and the air layer forming portion 200, A200, B200, or C200 to prevent the air which is convected in the air layer S from leaking into the contact area between the lower cover portion 300 and/or the upper cover portion 100 and the air layer forming portion 200, A200, B200, or C200.

That is, as shown in FIG. 9, the guide portion 400 may be disposed to be adjacent to a corner formed by the lower cover portion 300 and the air layer forming portion 200, A200, B200, or C200 and/or formed by the upper cover portion 100 and the air layer forming portion 200, A200, B200, or C200.

As a result thereof, the air which is convected in the air layer S may be guided by the guide portion 400 to not flow toward the corner formed by the lower cover portion 300 and the air layer forming portion 200, A200, B200, or C200 and/or formed by the upper cover portion 100 and the air layer forming portion 200, A200, B200, or C200.

Accordingly, it is possible to notably reduce a leak of the convected air into the adjacent air layer S through the space between the lower cover portion 300 and the air layer forming portion 200, A200, B200, or C200 or between the upper cover portion 100 and the air layer forming portion 200, A200, B200, or C200.

Also, as an example, the guide portion 400 may come into contact with the lower cover portion 300 and/or the upper cover portion 100 and may come into contact with the air layer forming portion 200, A200, B200, or C200 to increase the contact area between the lower cover portion 300 and/or the upper cover portion 100 and the air layer forming portion 200, A200, B200, or C200.

In more detail, the guide portion 400 may guide the convection path of the air on the air layer S simultaneously while coming into contact with the lower cover and the air layer forming portion 200, A200, B200, or C200 at the same time and transferring an unintended external force applied from the lower cover to the air layer forming portion 200, A200, B200, or C200.

Also, the guide portion 400 may come into contact with the upper cover and the air layer forming portion 200, A200, B200, or C200 at the same time and may transfer an unintended external force applied from the upper cover to the air layer forming portion 200, A200, B200, or C200.

As an example, the guide portion 400 may be disposed on each of the plurality of air layers S.

FIG. 10 illustrates a cross section of the insulating materials 10 in a direction perpendicular to a direction of a cross section of FIG. 9 and illustrates an elevation view of the guide portion 400 disposed on the air layer S.

As shown in FIG. 10, the guide portion 400 may extend along the air layer forming portion 200, A200, B200, or C200 and may have a thickness K1 at a first point and a thickness K2 at a second point spaced apart from the first point along the air layer forming portion 200, A200, B200, or C200 which are different from each other.

That is, the guide portion 400 may have different thicknesses in a height direction (up or downward direction in FIG. 10) and the thickness K1 at the first point may differ from the thickness K2 at the second point which are random positions.

As a result thereof, an eddy may be formed with respect to the air which is convected in the air layer S. Due to the eddy, it is possible to reduce the leak of the convected air into the adjacent air layer S through the space between the lower cover portion 300 and the air layer forming portion 200, A200, B200, or C200 or between the upper cover portion 100 and the air layer forming portion 200, A200, B200, or C200.

Also, the guide portion 400, as shown in FIG. 9, may have thickness in a width direction (in left and rightward direction in FIG. 9) which differs according to the air layer forming portions 200, A200, B200, and C200.

As a result thereof, the eddy may be formed with respect to the air which is convected in the air layer S.

As an example, the guide portion 400 may be a heat resistant metal material.

As an example, the guide portion 400 may be a thermosetting material.

Accordingly, the guide portion 400 may be disposed on the air layer S and strongly fixed to a certain position by heat treatment when an adhesive is applied and thermally treated for adhesion between the lower cover portion 300 and the air layer forming portion 200, A200, B200, or C200 and adhesion between the upper cover portion 100 and the air layer forming portion 200, A200, B200, or C200 without an additional process.

The guide portion 400 has been described as the metal material or thermosetting material but is not limited thereto and is variously changeable by those skilled in the art.

Hereinafter, insulating materials according to the second embodiment will be described in detail with reference to FIGS. 11 to 16.

As shown in FIGS. 11 to 16, insulating materials 1000 according to another embodiment of the present invention may be configured to reduce heat loss of a structure such as a building and the like.

As an example, the insulating materials 1000 may include an air layer forming portion 20000 which forms a plurality of air layers S, a lower cover portion 30000 which covers a lower side of the air layer forming portion 20000, and an upper cover portion 10000 which covers an upper side of the air layer forming portion 20000.

As an example, the lower cover portion 30000 and the upper cover portion 10000 may adhere to the air layer forming portion 20000 through an adhesive and the like.

As an example, adhesion between the lower cover portion 30000 and the air layer forming portion 20000 and adhesion between the upper cover portion 10000 and the air layer forming portion 20000 may be embodied by applying adhesives thereto and applying a thermal treatment of heating the portions with a certain heat.

Accordingly, the lower cover portion 30000 and the upper cover portion 10000 may insulate the air layers S from the outside.

As an example, the lower cover portion 30000 and the upper cover portion 10000 may be formed of an aluminum material but are not limited thereto and may be variously changed by those skilled in the art.

As an example, the air layer forming portion 20000 may have a certain thickness.

As an example, the air layer forming portion 20000 may form the plurality of air layers S which are divided from one other.

Hereinafter, a manufacturing process of the air layer forming portion 20000 will be described in detail with reference to FIGS. 13 and 15.

As an example, as shown in FIG. 13, the air layer forming portion 20000 may include a first air layer forming portion 21000 and a second air layer forming portion 22000 which extend in a longitudinal direction (up or downward direction in FIGS. 14 to 16).

As an example, a worker may apply an adhesive to a certain area A on the first air layer forming portion 21000. As shown in FIG. 14A, the worker may adhere the second air layer forming portion 22000 to the first air layer forming portion 21000.

Afterwards, as shown in FIG. 14B, the worker may form the air layers S by applying an external force F to the first air layer forming portion 21000 and the second air layer forming portion 22000 in a lateral direction (left and rightward direction in FIGS. 14A to 16) to space the first air layer forming portion 21000 and the second air layer forming portion 22000 apart in a part which does not correspond to the certain area A.

That is, the air layer forming portion 20000 may include the first air layer forming portion 21000 and the second air layer forming portion 22000 which partially adheres to the first air layer forming portion 21000 and forms the air layers S in cooperation with the first air layer forming portion 21000.

Also, as shown in FIG. 15, the worker may apply the external force F, which is intentionally preset, to the first air layer forming portion 21000 and the second air layer forming portion 22000 in the lateral direction to allow the air layers S which are adjacent to each other in the longitudinal direction to be alternate with each other.

That is, without an additional process, the worker may intentionally apply the preset external force F to form the air layers S simultaneously while forming the air layer forming portion 20000 such that the air layers S, which are adjacent in the longitudinal direction, are not aligned but alternate with each other.

Afterwards, the upper cover portion 10000 and the lower cover portion 30000 may be adhered to the upper side and the lower side of the air layer forming portion 20000.

A plurality of such air layer forming portions 20000 may be arranged on the upper cover portion 10000 and the lower cover portion 30000.

As an example, the air layer forming portions 20000 may be arranged to be spaced apart in a lateral direction and may be arranged in partial contact with one another.

As an example, the air layer forming portion 20000 may be a synthetic resin, metal, or paper material but is not limited thereto and is variously changeable by those skilled in the art.

Hereinafter, the air layer forming portion 20000 will be described in more detail with reference to FIGS. 15 and 16.

FIG. 16 illustrates a central line with respect to one of the air layer forming portions 20000 in FIG. 15 in order to more clearly explain the present invention in detail.

Accordingly, for convenience of description, the air layer forming portion 20000 will be easily described through reference numerals with respect to the central line of the air layer forming portion 20000 in FIG. 16.

As an example, the first air layer forming portion 21000 may include a 1-1 surface L1, a 1-2 surface L2 which is bent and extends from the 1-1 surface L1, and a 1-3 surface L3 which is bent and extends from the 1-2 surface L2 in order to form a first air layer S1 which is any one of the plurality of air layers S.

The second air layer forming portion 22000 may include a 2-1 surface L6, a 2-2 surface L5 which is bent and extends from the 2-1 surface L6, and a 2-3 surface L4 which is bent and extends from the 2-2 surface L5 in order to form the first air layer S1 in cooperation with the first air layer forming portion 21000.

That is, the 1-1 surface L1, the 1-2 surface L2, the 1-3 surface L3, the 2-1 surface L6, the 2-2 surface L5, and the 2-3 surface L4 may form the one first air layer S1 in cooperation with one another. The first air layer S1 may have a spatial shape which is an approximate quadrangle or that of a hexagon close to a quadrangle.

Here, as an example, the first air layer forming portion 21000 may include a 3-1 surface L7, a 3-2 surface L8 which is bent and extends from the 3-1 surface L7, and a 3-3 surface L9 which is bent and extends from the 3-2 surface L8 in order to form a second air layer S2 among the plurality of air layers S which is spaced apart from the first air layer S1 in the longitudinal direction.

The second air layer forming portion 22000 may include a 4-1 surface L12, a 4-2 surface L11 which is bent and extends from the 4-1 surface L12, and a 4-3 surface L10 which is bent and extends from the 4-2 surface L11 in order to form the second air layer S2 in cooperation with the first air layer forming portion 21000.

That is, the 3-1 surface L7, the 3-2 surface L8, the 3-3 surface L9, the 4-1 surface L12, the 4-2 surface L11, and the 4-3 surface L10 may form the one second air layer S2 in cooperation with one another. The second air layer S2 may have a spatial shape which is an approximate quadrangle or that of a hexagon close to a quadrangle.

The first air layer S1 and the second air layer S2 may be formed to be spaced a certain distance apart in the longitudinal direction.

Here, as an example, the first air layer forming portion 21000 may further include a first connection surface L13 which connects the 1-3 surface L3 to the 3-1 surface L7 such that an external force applied to the 1-3 surface L3 is transferred to the 3-1 surface L7 while the first air layer S1 and the second air layer S2 are spaced apart.

That is, one side of the first connection surface L13 may be connected to the 1-3 surface L3, and the other side of the first connection surface L13 may be connected to the 3-1 surface L7.

As an example, the first connection surface L13 may be bent and extend from the 1-3 surface L3 and may be bent and extend from the 3-1 surface L7.

The second air layer forming portion 22000 may further include a second connection surface L13 which connects the 2-3 surface L4 to the 4-1 surface L12 such that an external force applied to the 2-3 surface L4 is transferred to the 4-1 surface L12 while the first air layer S1 and the second air layer S2 are spaced apart.

That is, one side of the second connection surface L13 may be connected to the 2-3 surface L4, and the other side of the second connection surface L13 may be connected to the 4-1 surface L12.

As an example, the second connection surface L13 may be bent and extend from the 2-3 surface L4 and may be bent and extend from the 4-1 surface L12.

Here, as an example, the first connection surface L13 and the second connection surface L13 may adhere to each other so as to increase durability against an external force.

As an example, the first connection surface L13 and the second connection surface L13 may adhere to each other due to an adhesive and the like.

Accordingly, an external force applied to the first connection surface L13 may be transferred to the second connection surface L13.

Here, as an example, the 1-3 surface L3 and the 2-3 surface L4 may form a first apex X1 and the 3-1 surface L7 and the 4-1 surface L12 may form a second apex X2.

Here, as an example, the second apex X2 may be spaced apart from the first apex X1 in the lateral direction so as to increase durability against an external force applied in the longitudinal direction.

That is, the first apex X1 and the second apex X2 may not be aligned on a virtual axis in the longitudinal direction and may be arranged to be spaced apart in the lateral direction.

The first apex X1 may be an area where the 1-3 surface L3, the 2-3 surface L4, the first connection surface L13, and the second connection surface L13 meet one another and may be an area having high durability against an external force.

Likewise, the second apex X2 may be an area where the 3-1 surface L7, the 4-1 surface L12, the first connection surface L13, and the second connection surface L13 meet one another and may be an area having high durability against an external force.

The first apex X1 and the second apex X2, which have high durability against an external force, do not overlap with each other in the longitudinal direction and are spaced apart in the lateral direction such that the air layer forming portion 20000 may have significantly increased durability against an unintended external force.

Here, as an example, the 1-2 surface L2 and the 1-3 surface L3 may form a third apex X4, and the second apex X2 may be formed between the first apex X1 and the third apex X4 in the lateral direction.

That is, a virtual apex X3 where a virtual axis, which extends in the longitudinal direction on the basis of the second apex X2, and the 1-3 surface meet each other may be formed between the first apex X1 and the third apex X4 on the basis of the lateral direction.

As a result thereof, even when an unintended external force is applied between the first apex X1 and the third apex X4 in the longitudinal direction, the second apex X2 receives the external force such that the air layer forming portion 20000 may not be damaged.

Here, as an example, the first air layer forming portion 21000 may include a 5-1 surface L14, a 5-2 surface L15 which is bent and extends from the 5-1 surface L14, and a 5-3 surface L16 which is bent and extends from the 5-2 surface L15 in order to form a third air layer S3 among the plurality of air layers S which is spaced apart from the second air layer S2 in the longitudinal direction.

The second air layer forming portion 22000 may include a 6-1 surface L19, a 6-2 surface L18 which is bent and extends from the 6-1 surface L19, and a 6-3 surface L17 which is bent and extends from the 6-2 surface L18 in order to form the third air layer S3 in cooperation with the first air layer forming portion 21000.

That is, the 5-1 surface L14, the 5-2 surface L15, the 5-3 surface L16, the 6-1 surface L19, the 6-2 surface L18, and the 6-3 surface L17 may form the one third air layer S3 in cooperation with one another. The third air layer S3 may have a spatial shape which is an approximate quadrangle or that of a hexagon close to a quadrangle.

The second air layer S2 and the third air layer S3 may be formed to be spaced a certain distance apart in the longitudinal direction.

Here, as an example, the first air layer forming portion 21000 may further include a third connection surface L20 which connects the 3-3 surface L9 to the 5-1 surface L14 such that an external force applied to the 3-3 surface L9 is transferred to the 5-1 surface L14 while the second air layer S2 and the third air layer S3 are spaced apart.

That is, one side of the third connection surface L20 may be connected to the 3-3 surface L9, and the other side of the third connection surface L20 may be connected to the 5-1 surface L14.

As an example, the third connection surface L20 may be bent and extend from the 3-3 surface L9 and may be bent and extend from the 5-1 surface L14.

The second air layer forming portion 22000 may further include a fourth connection surface L20 which connects the 4-3 surface L10 to the 6-1 surface L19 such that an external force applied to the 4-3 surface L10 is transferred to the 6-1 surface L19 while the second air layer S2 and the third air layer S3 are spaced apart.

That is, one side of the fourth connection surface L20 may be connected to the 4-3 surface L10, and the other side of the fourth connection surface L20 may be connected to the 6-1 surface L19.

As an example, the fourth connection surface L20 may be bent and extend from the 4-3 surface L10 and may be bent and extend from the 6-1 surface L19.

As an example, the third connection surface L20 and the fourth connection surface L20 may adhere to each other due to an adhesive and the like.

Accordingly, an external force applied to the third connection surface L20 may be transferred to the fourth connection surface L20.

Here, as an example, the 3-3 surface L9 and the 4-3 surface L10 may form a fourth apex X5 and the 5-1 surface L14 and the 6-1 surface L19 may form a fifth apex X6.

Here, as an example, the fifth apex X6 may be spaced apart from the fourth apex X5 in the lateral direction so as to increase durability against an external force applied in the longitudinal direction.

That is, the fourth apex X5 and the fifth apex X6 may not be aligned on a virtual axis in the longitudinal direction and may be arranged to be spaced apart in the lateral direction.

The fourth apex X5 may be an area where the 3-3 surface L9, the 4-3 surface L10, the third connection surface L20, and the fourth connection surface L20 meet one another and may be an area having high durability against an external force.

Likewise, the fifth apex X6 may be an area where the 5-1 surface L14, the 6-1 surface L19, the third connection surface L20, and the fourth connection surface L20 meet one another and may be an area having high durability against an external force.

The fourth apex X5 and the fifth apex X6, which have high durability against an external force, do not overlap with each other in the longitudinal direction and are spaced apart in the lateral direction such that the air layer forming portion 20000 may have significantly increased durability against an unintended external force.

Here, as an example, an angle between a virtual straight line D1 which connects the first apex X1 to the second apex X2 and a virtual reference axis in the lateral direction may differ from an angle between a virtual straight line D2 which connects the fourth apex X5 to the fifth apex X6 and the virtual reference axis.

That is, at least some of the first apex X1, the second apex X2, the fourth apex X5, and the fifth apex X6 may be spaced apart in the lateral direction so as to increase durability against an unintended external force.

The technical features of the above-described insulating materials 10 according to a first embodiment and the insulating materials 1000 according to the second embodiment are not independent from each other and may be added to or changed by those skilled in the art.

As an example, the insulating materials 1000 according to the second embodiment may include the guide portion 400.

According to the embodiments of the present invention, insulating materials may provide an effect of maximizing insulating efficiency by using air layers.

Effects of the present invention will not be limited to the above-described effect, and unstated effects can be clearly understood by those skilled in the art through the specification and the attached drawings.

Although the components and features of the present invention have been described above on the basis of the embodiments of the present invention, it is obvious to those skilled in the art that the present invention is not limited thereto and a variety of changes and modifications may be made without departing from the concept and scope of the present invention. Therefore, it should be noted that the changes or modifications are included in the following claims.

What is claimed is:

1. Insulating materials which reduce heat loss, comprising:
an air layer forming portion which forms a plurality of air layers;
a lower cover portion which covers a lower side of the air layer forming portion; and
an upper cover portion which covers an upper side of the air layer forming portion,
wherein the lower cover portion and the upper cover portion insulate the air layers from the outside.

2. The insulating materials of claim 1, further comprising a guide portion which is disposed on the air layers and guides a convection path on the air layers.

3. The insulating materials of claim 2, wherein the guide portion is disposed to be adjacent to a contact area between the lower cover portion and/or the upper cover portion and the air layer forming portion so as to prevent air which is convected in the air layers from leaking into the contact area between the lower cover portion and/or the upper cover portion and the air layer forming portion.

4. The insulating materials of claim 3, wherein the guide portion comes into contact with the lower cover portion and/or the upper cover portion and comes into contact with the air layer forming portion so as to increase the contact area between the lower cover portion and/or the upper cover portion and the air layer forming portion.

5. The insulating materials of claim 4, wherein the guide portion extends along the air layer forming portion and has different thicknesses at a first point and a second point spaced apart from the first point along the air layer forming portion.

6. The insulating materials of claim 1, wherein the air layer forming portion comprises a first air layer forming portion and a second air layer forming portion which partially adheres to the first air layer forming portion to form the air layers in cooperation with the first air layer forming portion,
wherein the first air layer forming portion comprises a 1-1 surface, a 1-2 surface which is bent and extends from the 1-1 surface, and a 1-3 surface which is bent and extends from the 1-2 surface so as to form a first air layer which is one of the plurality of air layers,
wherein the second air layer forming portion comprises a 2-1 surface, a 2-2 surface which is bent and extends from the 2-1 surface, and a 2-3 surface which is bent and extends from the 2-2 surface so as to form the first air layer in cooperation with the first air layer forming portion,
wherein the first air layer forming portion comprises a 3-1 surface, a 3-2 surface which is bent and extends from the 3-1 surface, and a 3-3 surface which is bent and extends from the 3-2 surface so as to form a second air layer which is one of the plurality of air layers and is spaced apart from the first air layer in a longitudinal direction,
wherein the second air layer forming portion comprises a 4-1 surface, a 4-2 surface which is bent and extends from the 4-1 surface, and a 4-3 surface which is bent and extends from the 4-2 surface so as to form the second air layer in cooperation with the first air layer forming portion,
wherein the first air layer forming portion further comprises a first connection surface which connects the 1-3 surface to the 3-1 surface so as to transfer an external force applied to the 1-3 surface to the 3-1 surface while the first air layer and the second air layer are spaced apart,
wherein the second air layer forming portion further comprises a second connection surface which connects the 2-3 surface to the 4-1 surface so as to transfer an external force applied to the 2-3 surface to the 4-1 surface while the first air layer and the second air layer are spaced apart, and
wherein the first connection surface and the second connection surface adhere to each other so as to increase durability against an external force.

7. The insulating materials of claim 6, wherein the 1-3 surface and the 2-3 surface form a first apex,
wherein the 3-1 surface and the 4-1 surface form a second apex, and
wherein the second apex is spaced apart from the first apex in a lateral direction so as to increase durability against an external force applied in the longitudinal direction.

8. The insulating materials of claim 7, wherein the 1-2 surface and the 1-3 surface form a third apex, and
wherein the second apex is formed between the first apex and the third apex in a lateral direction.

9. The insulating materials of claim 8, wherein the first air layer forming portion comprises a 5-1 surface, a 5-2 surface which is bent and extends from the 5-1 surface, and a 5-3 surface which is bent and extends from the 5-2 surface so as to form a third air layer which is one of the plurality of air layers and is spaced apart from the second air layer,
wherein the second air layer forming portion comprises a 6-1 surface, a 6-2 surface which is bent and extends from the 6-1 surface, and a 6-3 surface which is bent and extends from the 6-2 surface so as to form the third air layer in cooperation with the first air layer forming portion,
wherein the first air layer forming portion further comprises a third connection surface which connects the 3-3 surface to the 5-1 surface so as to transfer an external force applied to the 3-3 surface to the 5-1 surface while the second air layer and the third air layer are spaced apart,
wherein the second air layer forming portion further comprises a fourth connection surface which connects the 4-3 surface to the 6-1 surface so as to transfer an external force applied to the 4-3 surface to the 6-1 surface while the second air layer and the third air layer are spaced apart,
wherein the 3-3 surface and the 4-3 surface form a fourth apex,
wherein the 5-1 surface and the 6-1 surface form a fifth apex, and
wherein the fifth apex is spaced apart from the fourth apex in the lateral direction so as to increase durability against an external force applied in the longitudinal direction.

10. The insulating materials of claim 9, wherein an angle between a virtual straight line, which connects the first apex to the second apex, and a virtual reference axis in the lateral direction differs from an angle between a virtual straight line, which connects the fourth apex to the fifth apex, and the virtual reference axis.
